(19) United States
(12) Patent Application Publication
(10) Pub. No.: US 2010/0284684 A1
(43) Pub. Date: Nov. 11, 2010

(54) IMAGING BODY AND IMAGING DEVICE HAVING THE SAME

(75) Inventors: Toshifumi Nakano, Sagamihara-shi (JP); Tatsuya Suzuki, Setagaya-ku (JP); Hisashi Goto, Suginami-ku (JP)

Correspondence Address: DICKSTEIN SHAPIRO LLP, 1633 Broadway, NEW YORK, NY, 10019, US

(73) Assignee: Olympus Corporation, Tokyo (JP)

(21) Appl. No.: 12/844,955

(22) Filed: Jul. 28, 2010

Related U.S. Application Data
(63) Continuation of application No. PCT/JP2009/050858, filed on Jan. 21, 2009.

(30) Foreign Application Priority Data
Jan. 28, 2008 (JP) 2008-016335
Jan. 28, 2008 (JP) 2008-016336

(51) Int. Cl. G03B 17/00

(52) U.S. Cl. 396/439

(57) ABSTRACT

An imaging body (1) includes: an attachment/detachment portion (2) to which an imaging optical system is detachably attached; an optical path division means (3); an imaging element (4); and a conversion optical system (5, 5′). The conversion optical system (5, 5′) is formed by a front lens system (5a, 5c, 5d) and a rear lens system (5b, 5e). The front lens system (5a, 5c, 5d) is disposed between the attachment/detachment portion (2) and the optical path division means (3). The rear lens system (5b, 5e) is disposed between the optical path division means (3) and the imaging element (4).

### BACKGROUND OF THE INVENTION AND RELATED ART

The present invention relates to an imaging body in which an imaging optical system is detachably configured and an imaging device having the imaging body.

There is known a camera capable of exchanging an imaging element with another imaging element of a different size according to the purpose (refer to Patent Document 1). This camera has a horizontally-long box-like camera body and a photographing lens for silver salt single-lens reflex camera. As the camera body, a camera body for silver salt single-lens reflex camera is used without modification. As a back lid, one for silver-salt camera and one for digital camera are prepared. When the back lid for digital camera is attached to the camera body, this camera can be used as a digital camera. Further, this camera has a configuration allowing exchange of a CCD substrate and thus different types of digital cameras can be realized by one camera body.

Patent Document 1: JP-A-2000-59655

### SUMMARY OF THE INVENTION

According to a first aspect of the present invention, there is provided an imaging body including: an attachment/detachment portion to which an imaging optical system is detachably attached; an optical path division means; an imaging element; and an conversion optical system, wherein the conversion optical system is constituted by a front side lens system and rear side lens system, the front side lens system is disposed between the attachment/detachment portion and optical path division means, and the rear side lens system is disposed between the optical path division means and imaging element.

The conversion optical system is an optical system that does not form an intermediate image inside the imaging body.

In the case where the conversion optical system is an optical system that does not form an intermediate image, the front side lens system has a negative refractive power and rear side lens system has a positive refractive power.

The conversion optical system is an optical system that forms an intermediate image inside the imaging body.

In the case where the conversion optical system is an optical system that forms an intermediate image, the front side lens system has a positive refractive power and rear side lens system has a positive refractive power.

In the case where the conversion optical system is an optical system that forms an intermediate image, the front side lens system includes a positive refractive power lens disposed near the intermediate image and another positive refractive power lens.

An imaging device according to the present invention includes the imaging body according to the first aspect of the present invention and the imaging optical system.

According to a second aspect of the present invention, there is provided an imaging body comprising: an attachment/detachment portion to which an imaging optical system is detachably attached; an optical path division means; an imaging element; and an conversion optical system, wherein the conversion optical system is constituted by a front side lens system and rear side lens system, and the imaging body further comprises a first moving mechanism for moving the optical path division means between a first position and a second position and a second moving mechanism for moving the front side lens system between the first position and a third position.

When the optical path division means is moved to the second position, the second moving mechanism moves the front side lens system to the first position.

The conversion optical system is an optical system that does not form an intermediate image inside the imaging body.

The conversion optical system is an optical system that forms an intermediate image inside the imaging body.

An imaging device according to the present invention includes the imaging body according to the second aspect of the present invention and the imaging optical system.

### BRIEF DESCRIPTION OF THE DRAWINGS

FIG. 1 is a view illustrating an imaging body according to a first embodiment of the present invention;

FIG. 2 is a view illustrating another configuration of a conversion optical system;

FIG. 3 is a view illustrating an imaging device according to the present invention;

FIG. 4 is a view illustrating the imaging body according to a second embodiment of the present invention in which an optical path division means is located at a first position;

FIG. 5 is a view illustrating the imaging body according to the second embodiment of the present invention in which a front side lens system is located at the first position;

FIG. 6 is a view illustrating another configuration of the conversion optical system; and

FIG. 7 is a view illustrating the imaging device according to the present invention.

### DETAILED DESCRIPTION OF PREFERRED EMBODIMENT

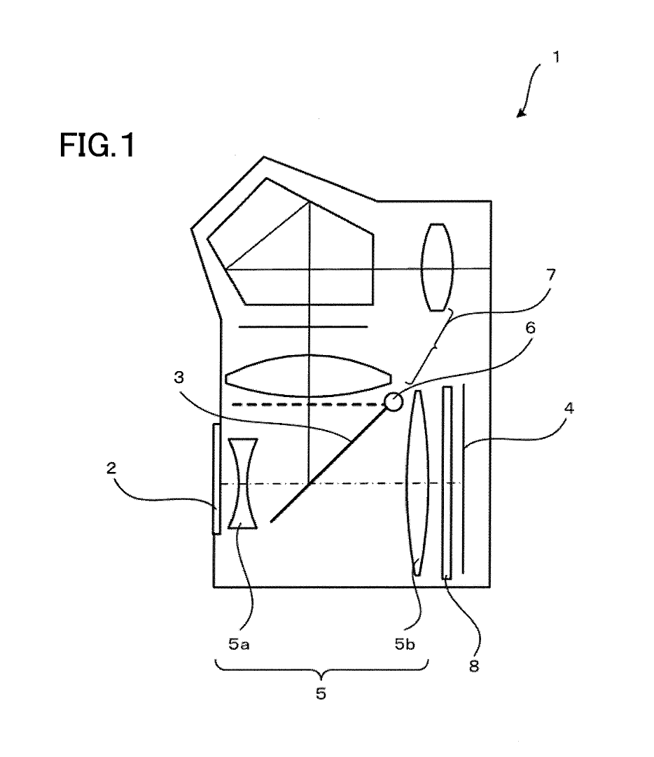

A first embodiment of the present invention will be described. FIG. 1 illustrates an imaging body according to the first embodiment. As illustrated in FIG. 1, an imaging body 1 includes an attachment/detachment portion 2, an optical path division means 3, an imaging element 4, a conversion optical system 5, a moving mechanism 6, and a finder optical system 7. The attachment/detachment portion 2 is, e.g., a bayonet ring. An imaging optical system can detachably be attached to the imaging body through the attachment/detachment portion 2.

The optical path division means 3 is. e.g., a mirror (quick return mirror). The mirror can be moved between first and second positions by the moving mechanism 6. The first position is indicated by a solid line. The first position is located between the attachment/detachment portion 2 and imaging element 4. The second position is indicated by a broken line. The second position is a position near the finder optical system 7 which is obtained by rotating the optical path division means 3 by 45 degrees. It appears in FIG. 1 that the optical path division means 3 may contact the conversion optical system 5 when the optical path division means 3 is moved between the first and second positions. Actually, however, a sufficient distance is ensured between the optical path division means 3 and conversion optical system 5, so that the contact between then does not occur.

The imaging element 4 is disposed opposite to the attachment/detachment portion 2 with respect to the first position. An image of a subject is formed at this position when the imaging optical system is attached. Further, in the first embodiment, a filter 8 is disposed in front of the imaging element 4.

The conversion optical system 5 is disposed between the attachment/detachment portion 2 and imaging element 4. The conversion optical system 5 is constituted by a front side lens system 5a and a rear side lens system 5b. The front side lens system 5a is disposed between the attachment/detachment portion 2 and optical path division means 3 (first position). The rear side lens system 5b is disposed between the optical path division means 3 (first position) and imaging element 4.

As described above, the imaging body 1 of the first embodiment includes the conversion optical system 5 inside thereof. Thus, a large subject image can be formed on the entire light receiving section by the conversion optical system 5. As a result, an element having a large light receiving section can be used as the imaging element 4. Even in an imaging optical system for an imaging device having a small light receiving section, a large subject image can be formed by means of the conversion optical system 5. This provides an advantage that an existing imaging optical system can be used.

The front side lens system 5a has preferably a negative refractive power. On the other hand, the rear side lens system 5b has preferably a positive refractive power. With this configuration, a large subject image can be formed. In FIG. 1, the front side lens system 5a and rear side lens system 5b are each constituted by one lens. However, the front side lens system 5a and rear side lens system 5b each may be constituted by a plurality of lenses.

The conversion optical system 5 is an optical system that does not form an intermediate image (primary image). Thus, the thicknesses of the optical system and imaging body 1 can be reduced.

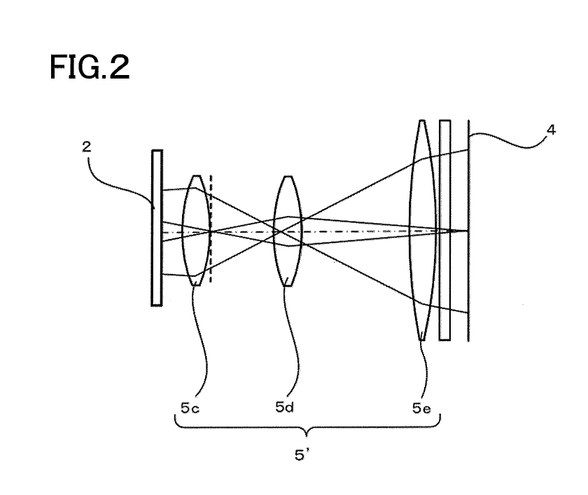

Another example of the conversion optical system is illustrated in FIG. 2. A conversion optical system 5′ is disposed between the attachment/detachment portion 2 and imaging element 4. The conversion optical system 5′ is constituted by front side lens systems 5c, 5d and a rear side lens system 5e. The front side lens systems 5c and 5d have a positive refractive power as a whole. The rear side lens system 5d has a positive refractive power as a whole.

Although not illustrated in FIG. 2, the optical path division means 3 (first position) is disposed between the lens 5d (front side lens system) and rear side lens system 5e. That is, the front side lens systems 5c and 5d are disposed between the attachment/detachment portion 2 and optical path division means 3 (first position), and the rear side lens system 5e is disposed between the optical path division means 3 (first position) and imaging element 4.

The front side lens systems 5c and 5d have a positive refractive power lens 5c disposed near an intermediate image and another positive refractive power lens 5d. The lens 5c, which is disposed near an intermediate image, functions as a field lens.

The conversion optical system 5′ is an optical system that forms an intermediate image (primary image). Thus, even when a subject image is enlarged, an aberration-free image can be obtained.

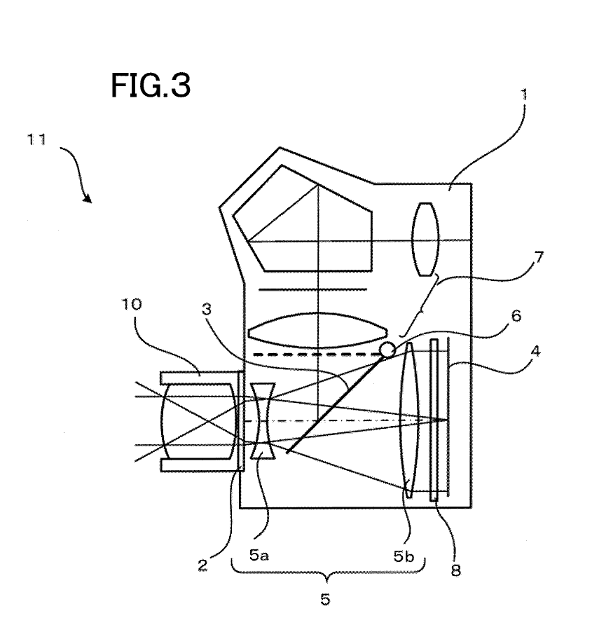

An imaging device 11 according to the first embodiment is illustrated in FIG. 3. The imaging device 11 according to the first embodiment has the imaging body 1 and an imaging optical system 10. The imaging optical system 10 is connected to the imaging body 1 through the attachment/detachment portion 2. Thus, a subject image is formed on the imaging element 4 through the imaging optical system 10 and conversion optical system 5.

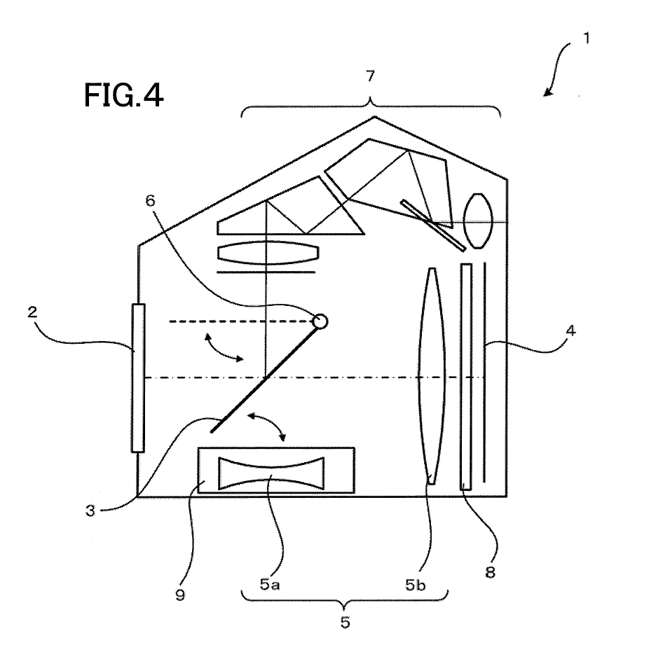

A second embodiment of the present invention will be described. The imaging body according to the second embodiment is illustrated in FIG. 4. In FIG. 4, an imaging body 1 includes an attachment/detachment portion 2, an optical path division means 3, an imaging element 4, conversion optical system 5, a first moving mechanism 6, a finder optical system 7, and a second moving mechanism 9. The attachment/detachment portion 2 is, e.g., a bayonet ring. An imaging optical system can detachably be attached to the imaging body through the attachment/detachment portion 2.

The optical path division means 3 is. e.g., a mirror (quick return mirror). The mirror can be moved between first and second positions by the moving mechanism 6. The first position is indicated by a solid line. The first position is located between the attachment/detachment portion 2 and imaging element 4. The second position is indicated by a broken line. The second position is a position near the finder optical system 7 which is obtained by rotating the optical path division means 3 by 45 degrees.

The imaging element 4 is disposed opposite to the attachment/detachment portion 2 with respect to the first position. An image of a subject is formed at this position when the imaging optical system is attached. Further, in the second embodiment, a filter 8 is disposed in front of the imaging element 4.

The conversion optical system 5 is disposed between the attachment/detachment portion 2 and imaging element 4. The conversion optical system 5 is constituted by a front side lens system 5a and a rear side lens system 5b. The front side lens system 5a is disposed near the first position. The rear side lens system 5b is disposed between the optical path division means 3 (first position) and imaging element 4.

The imaging body according to the second embodiment has the second moving mechanism 9. The second moving mechanism 9 is provided for moving the front side lens system 5a. The use of the second moving mechanism 9 allows the optical path division means 3 to be moved between the first position and a third position. The third position is a retreat position of the front side lens system 5a. The retreat position is, e.g., a bottom portion of the imaging body 1. When the front side lens system 5a is moved to the retreat position, a translation mechanism, a rotation mechanism or a combination thereof may be used.

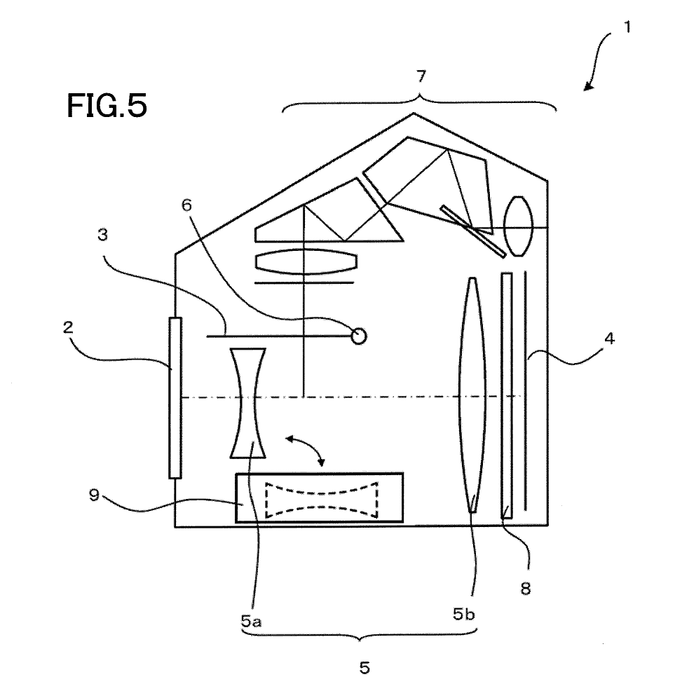

In the second embodiment, one of the optical path division means 3 and front side lens system 5a is moved to the first position. FIG. 4 illustrates a case where the optical path division means 3 has been moved to the first position. In this state, the front side lens system 5a has been moved to the retreat position so as to avoid contact (collision) with the optical path division means 3. FIG. 5 illustrates a case where the optical path division means 3 has been moved to the second position. In this state, the front side lens system 5a has been moved to the first position.

As described above, the imaging body 1 of the second embodiment includes the conversion optical system 5 inside thereof. Thus, a large subject image can be formed on the entire light receiving section by the conversion optical system 5. As a result, an element having a large light receiving section can be used as the imaging element 4. The imaging body 1 further includes the second moving mechanism 9 for moving the front side lens system 5a. Thus, the first position can be shared between the optical path division means 3 and front side lens system 5a. As a result, the thickness of the imaging body can be reduced.

Even in an imaging optical system for an imaging device having a small light receiving section, a large subject image can be formed by means of the conversion optical system 5. This provides an advantage that an existing imaging optical system can be used.

The front side lens system 5a has preferably a negative refractive power. On the other hand, the rear side lens system 5b has preferably a positive refractive power. With this configuration, a large subject image can be formed. In FIG. 4, the front side lens system 5a and rear side lens system 5b are each constituted by one lens. However, the front side lens system 5a and rear side lens system 5b each may be constituted by a plurality of lenses.

The conversion optical system 5 is an optical system that does not form an intermediate image (primary image). Thus, the thicknesses of the optical system and imaging body 1 can be reduced.

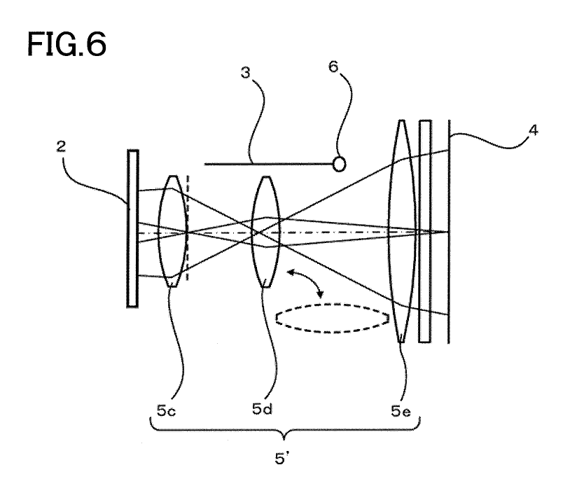

Another configuration of the conversion optical system 5 is illustrated in FIG. 6. A conversion optical system 5′ is disposed between the attachment/detachment portion 2 and imaging element 4. The conversion optical system 5′ is constituted by front side lens systems 5c, 5d and a rear side lens system 5e. The front side lens systems 5c and 5d have a positive refractive power as a whole. The rear side lens system 5d has a positive refractive power as a whole.

The optical path division means 3 can be moved between the positions of the front side lens systems 5c and 5d. Thus, at least one of the front side lens system 5c and 5d is configured to be movable to its retreat position. In the example of FIG. 6, the optical path division means 3 is moved to the position of the lens 5d. Accordingly, the lens 5d is configured to be movable to its retreat position.

The front side lens systems 5c and 5d have a positive refractive power lens 5c disposed near an intermediate image and another positive refractive power lens 5d. The lens 5c, which is disposed near an intermediate image, functions as a field lens.

The conversion optical system 5′ is an optical system that forms an intermediate image (primary image). Thus, even when a subject image is enlarged, an aberration-free image can be obtained.

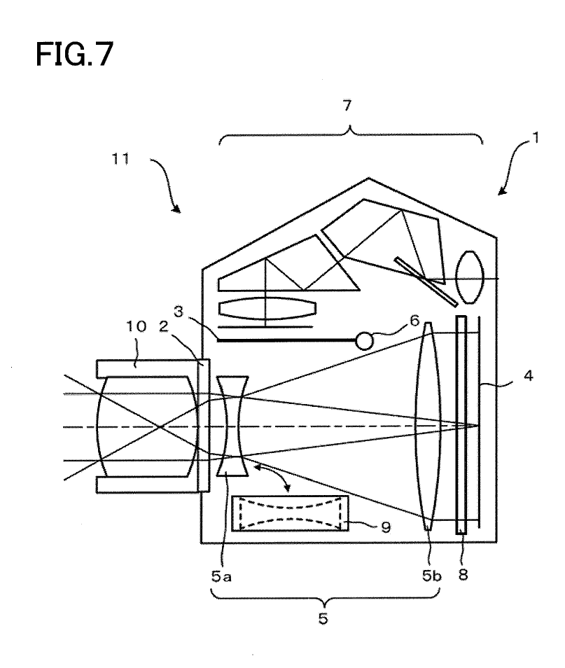

An imaging device 11 according to the second embodiment is illustrated in FIG. 7. The imaging device 11 according to the second embodiment has the imaging body 1 and imaging optical system 10. The imaging optical system 10 is connected to the imaging body 1 through the attachment/detachment portion 2. Thus, a subject image is formed on the imaging element 4 through the imaging optical system 10 and conversion optical system 5.

According to the above embodiments, an imaging body capable of using an imaging element having a large image receiving area and an imaging device having the imaging body can be obtained.

The present invention may be variously modified without departing the scope thereof.

What is claimed is:

1. An imaging body comprising:
an attachment/detachment portion to which an imaging optical system is detachably attached;
optical path division means;
an imaging element; and
an conversion optical system, wherein
the conversion optical system is constituted by a front side lens system and rear side lens system,
the front side lens system is disposed between the attachment/detachment portion and optical path division means, and
the rear side lens system is disposed between the optical path division means and imaging element.

2. The imaging body according to claim 1, wherein
the conversion optical system is an optical system that does not form an intermediate image inside the imaging body.

3. The imaging body according to claim 1, wherein
the front side lens system has a negative refractive power and rear side lens system has a positive refractive power.

4. The imaging body according to claim 1, wherein
the conversion optical system is an optical system that forms an intermediate image inside the imaging body.

5. The imaging body according to claim 1, wherein
the front side lens system has a positive refractive power and rear side lens system has a positive refractive power.

6. The imaging body according to claim 5, wherein
the front side lens system includes a positive refractive power lens disposed near the intermediate image and another positive refractive power lens.

7. An imaging device having the imaging body as claimed in claim 1 and the imaging optical system.

8. An imaging body comprising:
an attachment/detachment portion to which an imaging optical system is detachably attached;
optical path division means;
an imaging element; and
an conversion optical system, wherein
the conversion optical system is constituted by a front side lens system and rear side lens system, and
the imaging body further comprises a first moving mechanism for moving the optical path division means between a first position and a second position and a second moving mechanism for moving the front side lens system between the first position and a third position.

9. The imaging body according to claim 8, wherein
when the optical path division means is moved to the second position, the second moving mechanism moves the front side lens system to the first position.

10. The imaging body according to claim 8, wherein
the conversion optical system is an optical system that does not form an intermediate image inside the imaging body.

11. The imaging body according to claim 8, wherein
the conversion optical system is an optical system that forms an intermediate image inside the imaging body.

12. An imaging device having the imaging body as claimed in claim 8 and the imaging optical system.
